(19) United States
(12) Patent Application Publication
(10) Pub. No.: US 2024/0018436 A1
(43) Pub. Date: Jan. 18, 2024

(54) Process for Obtaining Solid Recovered Fuel and Synthesis Gas from a Waste-based Feedstock

(71) Applicant: VELOCYS TECHNOLOGIES LIMITED, Oxford (GB)

(72) Inventors: Philip Ivan GREAGER, Houston, TX (US); Roger Allen HARRIS, Houston, TX (US); Martin HOPKINS, High Peak (GB); Neil Alexander KING, Oxford (GB); Malcolm John WARD, Tonbridge (GB)

(21) Appl. No.: 18/255,173

(22) PCT Filed: Dec. 1, 2021
(86) PCT No.: PCT/EP2021/083736

§ 371 Date: May 31, 2023

Related U.S. Application Data
(60) Provisional application No. 63/120,786, filed on Dec. 3, 2020.

(30) Foreign Application Priority Data
Dec. 11, 2020 (GB) 2019576.4

(51) Int. Cl. C10J 3/72; C10J 3/46; C10K 1/00; C10L 5/48

(52) U.S. Cl. CPC C10J 3/723; C10J 3/463; C10K 1/004; C10K 1/002; C10L 5/48; C10L 2290/04; C10L 2290/28; C10L 2290/546; C10J 2300/0906; C10J 2300/0909; C10J 2300/0946; C10J 2300/0959; C10J 2300/0976; C10J 2300/0989; C10J 2300/1246; C10J 2300/1618

(57) ABSTRACT

The present invention provides a process for obtaining solid recovered fuel and synthesis gas from a waste-based feedstock, comprising the steps of:
I. converting the feedstock into a solid recovered fuel by means of a number of parameters pertaining to waste sorting, selection, comminution and/or screening;
II. gasifying under suitable reaction conditions at least a portion of the solid recovered fuel to produce synthesis gas and by-product(s); and
III. optionally cleaning at least a portion of the synthesis gas to produce clean synthesis gas and wastewater,
wherein one or more of the solid recovered fuel, synthesis gas, and by-product(s) of the gasification are analysed during operation of the process, and wherein data from said analysis is used to control one or more parameters of step I) in order to influence reaction conditions in step II, and optionally step III).

This application is a National Stage application claims priority from the international application PCT/EP2021/083736, filed Dec. 1, 2021, which claims priority from the U.S. Provisional Application 63/120,786, filed Dec. 3, 2020; and GB application No. 2019576.4 filed Dec. 11, 2020. The entirety of the aforementioned applications is incorporated herein by reference.

### FIELD

The present invention concerns a process for obtaining solid recovered fuel (SRF) and synthesis gas from a waste-based feedstock.

### BACKGROUND

There is a political motivation from laws and regulations to increase the recycle and reuse of waste materials, and to reduce the amount of waste materials which are disposed of in landfill or incinerated. It is widely known in the art to manufacture useful products such as synthetic fuels from waste materials. We may refer to such a manufacturing method as a WTL (Waste-to-Liquids) process.

Typical WTL processes involve the gasification of waste feedstock to produce a synthesis gas which may then be treated and purified in various ways before entering a chemical reaction operation to generate a useful product. Gasification is a proven and environmentally-sound method of converting the energy present in waste materials into useful products.

The Fischer-Tropsch (FT) process is widely used to generate fuels from carbon monoxide and hydrogen (synthesis gas) and can be represented by the equation:

(2n+1)H₂+nCO→CₙH₂ₙ₊₂+nH₂O

Unless the context dictates otherwise, the terms “raw synthesis gas”, “clean synthesis gas” and any other phrase containing the term “synthesis gas” are to be construed to mean a gas primarily comprising hydrogen and carbon monoxide. Other components such as carbon dioxide, nitrogen, argon, water, methane, tars, acid gases, higher molecular weight hydrocarbons, oils, volatile metals, char, phosphorus, halides, and ash may also be present. The concentration of contaminants and impurities present will be dependent on the stage of the process and feedstock source.

The use of such terms to describe synthesis gas should not be taken as limiting. The skilled person would understand that each of the terms is construed to mean a gas primarily comprising hydrogen and carbon monoxide.

The process of converting a feedstock into solid recovered fuel is known in the art. However, the specific steps of said process can vary considerably. Similarly, the process of gasifying solid recovered fuel to produce synthesis gas is also known in the art. It is also known in the art that many materials, such as metals and glass, must be removed from the feedstock before it can be fed into the gasifier. These removed materials can advantageously be recycled, such that gasification and recycling are complementary techniques for effectively handling waste materials. Therefore, the process of converting a feedstock into solid recovered fuel involves the removal of several types of materials so that a high-quality solid recovered fuel can be produced.

U.S. Pat. No. 4,063,903 describes an apparatus for the disposal of solid wastes by converting the organic fraction of such wastes to a fuel or fuel supplement and by recovering one or more of the constituents of the inorganic fashion.

US2013092770 describes methods and systems for mining high value recyclable materials from a mixed solid waste stream. The method and systems can use sizing and density separation to produce intermediate waste streams that can be properly sorted to extract large percentages of valuable recyclable materials.

EP2711411 describes a process for producing solid recovered fuel, comprising a step of processing starting materials in a homogenization extruder machine.

WO2011138591 describes a process for the treatment of hazardous waste, the process comprising providing a hazardous waste; providing a waste stream; gasifying the waste stream in a gasification unit to produce an offgas and a char material; and plasma treating the offgas in a plasma treatment unit to produce a syngas. The hazardous waste is blended with the waste stream at a point in the process determined by the relative chemical and/or physical properties of the hazardous waste and the waste stream.

KR20180043911 describes a power generation system using waste gasification, which includes a power generation unit that performs a power generation process using a syngas generated through a pre-treatment process of waste.

US2011289845 describes treating organic and inorganic materials in a metal bath contained in a high temperature reactor to produce synthesis gas.

GB2511111 describes an apparatus for pyrolysing or gasifying material containing an organic content.

US2017009160 and GB2510642 describe systems and methods for converting waste material to a syngas.

WO2020092511 describes a method of manufacturing a solid recovered fuel, said method comprising: conveying a first stream of solid waste to a pre-shredding unit comprising a trommel; separating, with the trommel, the first stream of solid waste into a second stream of solid waste and a third stream of solid waste; conveying the second stream of solid waste to a primary shredding unit comprising a primary shredder; shredding the second stream of solid waste to produce a fourth stream of solid waste with the primary shredder; conveying the fourth stream of solid waste to a solid recovered fuel production unit; and producing a stream of solid recovered fuel with the solid recovered fuel production unit.

Furthermore, feedstock-to-SRF processes of the art typically only sample and analyse the solid recovered fuel at the end of the process, ensuring that it has the correct moisture content and physical composition. This analysis may provide feedback to the feedstock-to-SRF process in order to adjust the composition of the SRF by targeting more or less of certain materials. This technique has been employed at, for example, the SUEZ SRF plant in Rugby, United Kingdom.

However, feedstock-to-SRF processes and gasification processes are typically separated (and thus may be performed at different locations), with the latter having no immediate impact or influence on the former. Therefore, an integrated process comprising the manufacture of solid recovered fuel and the gasification of said solid recovered fuel, with responsive feedback loops at all stages of the process, has not hitherto been realised.

### BRIEF DESCRIPTION OF THE DRAWINGS

FIG. 1 illustrates the process of obtaining solid recovered fuel from a feedstock in accordance with one embodiment of the invention.

FIG. 2 illustrates the feedback loops involved in steps I) and II) of the process in accordance with one embodiment of the invention.

FIG. 3 illustrates the feedback loops involved in steps I), II) and III) of the process in accordance with one embodiment of the invention.

### DETAILED DESCRIPTION

According to a first aspect of the present invention, there is provided a process for obtaining solid recovered fuel and synthesis gas from a waste-based feedstock, comprising the steps of:

converting the feedstock into a solid recovered fuel by means of a number of parameters pertaining to waste sorting, selection, comminution and/or screening;

gasifying under suitable reaction conditions at least a portion of the solid recovered fuel to produce synthesis gas and by-product(s); and

optionally cleaning at least a portion of the synthesis gas to produce clean synthesis gas and wastewater,

wherein one or more of the solid recovered fuel, synthesis gas, and by-product(s) of the gasification are analysed during operation of the process, and wherein data from said analysis is used to control one or more parameters of step I) in order to influence reaction conditions in step II, and optionally step III).

The inventors of the present invention have found that the inventive integrated process is able to control the generation of synthesis gas through waste sorting and calorific sorting. This is achieved by analysing the products and by-products of various steps of the process and using data from said analysis to control parameters of step I) in order to influence reaction conditions throughout the integrated process. In other words, the inventors have found that the step of converting feedstock into solid recovered fuel can be controlled responsive to real-time analytical feedback from one or more, or all, stages of the integrated process. By way of an example, the caustic consumption of wastewater treatment, gasifier temperature, and/or moisture content of the solid recovered fuel or synthesis gas can be analysed, and feedstock streams selected responsive to data from said analysis.

The inventors have also found that by carefully selecting the feedstock types and removing certain amounts of undesirable materials from the feedstock, the mass flows, energy consumption of the gasifier and output of the gasifier can be controlled as desired.

The inventors have found that the inventive process is particularly effective in managing daily fluctuations in the feedstock quality, whereas traditional proportional-integral-derivative (PID) controllers are responsible for minute-to-minute changes in the process.

Preferably, the process comprises gasifying under suitable reaction conditions a portion of the solid recovered fuel to produce synthesis gas and by-product(s). In other words, not all of the solid recovered fuel is gasified in the process. The process advantageously results in a net generation of solid recovered fuel.

Therefore, according to another aspect of the present invention, there is provided a process for obtaining solid recovered fuel and synthesis gas from a waste-based feedstock, comprising the steps of:

converting the feedstock into a solid recovered fuel;

gasifying under suitable reaction conditions a portion of the solid recovered fuel to produce synthesis gas and by-product(s); and

optionally cleaning at least a portion of the synthesis gas to produce clean synthesis gas and wastewater,

wherein one or more of the synthesis gas and by-product(s) of the gasification are analysed during operation of the process, and wherein data from said analysis is used to control one or more parameters of step I) pertaining to waste sorting, selection, comminution and/or screening in order to influence reaction conditions in step II.

Data from said analysis may also be used to control one or more parameters of step I) pertaining to waste sorting, selection, comminution and/or screening in order to influence reaction conditions in step III.

The feedstock may optionally comprise one or more of household waste (also termed municipal waste), commercial and industrial waste, and co-collected household and commercial waste. Municipal solid waste may typically include “trash” such as kitchen waste, electronics, light bulbs, plastics, used tires, old paint, and yard waste.

The feedstock will have fluctuating compositional characteristics that are dependent on the source and chemistry of the feedstock used. The material composition can vary significantly with regards to the amount of plastics, papers, inerts, food waste from batch to batch as well as seasonally.

The feedstock may be in the form of relatively large pieces or may comprise relatively large pieces. The feedstock may optionally be pre-processed to remove oversized items.

The feedstock may be diversified in terms of fractional composition. The feedstock is preferably defined as comprising four size fractions: fine (wherein the particles do not exceed about 6 mm), small (wherein the particles have a size of from about 6 to about 20 mm), main (wherein the particles have a size of from about 20 to about 60 mm), and coarse (wherein the particles have a size of above about 60 mm).

It is difficult to accurately distinguish the boundary between the main and coarse fractions. Therefore, depending on the properties of the two fractions, the boundary may be in the range of from about 60 to about 100 mm.

Furthermore, the boundary between the four size fractions may optionally be a parameter to be controlled, and may be dependent on the nature of the feedstock. This would permit control over the quantity of materials present in each fraction. By way of a non-limiting example, the boundary between the main and coarse fractions may be increased to 100 mm to reduce the amount of materials in the coarse fraction and increase the amount of materials in the main fraction.

By way of another non-limiting example, if the feedstock comprises predominantly larger materials, the boundary between the main and coarse fractions may be increased to 100 mm to compensate for the lack of smaller materials and to evenly distribute materials between the fractions.

The coarse fraction may also be preferably defined as comprising three fractions: heavy coarse, medium coarse, and light coarse. The heavy coarse fraction may for example comprise inerts and/or glass. The light coarse fraction may for example comprise paper and/or plastics. The medium coarse fraction may for example comprise heavier paper (as compared to the paper present in the light coarse fraction), card and/or plastics such as polyvinyl chloride.

The fine feed may for example optionally comprise biogenic material, stone, and/or glass.

### Process Details

Step I) comprises converting the feedstock into a solid recovered fuel by means of a number of parameters pertaining to waste sorting, selection, comminution and/or screening. The parameters of step I) may optionally comprise:

providing a feedstock which comprises a fine feed, a small feed, a main feed, and a coarse feed;

shredding the feedstock to a first size;

subjecting the feedstock to a first screening, which separates the fine feed, small feed and main feed from the coarse feed;

subjecting the fine feed, small feed and main feed to a second screening, which separates the fine feed, the small feed, and the main feed;

subjecting the coarse feed to a third screening, which separates the coarse feed into a light coarse feed, a medium coarse feed, and a heavy coarse feed;

conveying one or more of the small feed, the main feed, the light coarse feed, and/or the medium coarse feed over one or more magnets to remove ferrous and/or non-ferrous metals from said one or more feeds;

near-infrared scanning the medium coarse feed to identify and remove one or more plastics;

subjecting the main feed to a density separation;

shredding the small feed, the main feed, the light coarse feed, and the medium coarse feed to a second size;

combining the small feed, the main feed, the light coarse feed, and the medium coarse feed into a final feed; and

drying the final feed, optionally by using a belt dryer, to produce a solid recovered fuel.

The first screening may optionally be a trommel screen or a star screen. The second screening may optionally be a flip-flop screen or a density separator. The third screening may optionally be a wind sifter or an air knife. Any of the first, second, and/or third screening may optionally be a vibrating screen.

The first size may optionally be about 250 mm. The second size may optionally be about 25 mm.

The plastics may optionally comprise one or more of a halogenated plastic, a polyolefin, polystyrene, polyacrylonitrile, a polyacrylate, a polyurethane, a polyamide, a polyester, a polycarbonate, and/or an elastomer. The halogenated plastic may optionally comprise polyvinyl chloride. The polyester may optionally comprise polyethylene terephthalate (PET). The polyolefin may optionally comprise one or more of low-density polyethylene (LDPE), linear low-density polyethylene (LLDPE), medium-density polyethylene (HDPE), high-density polyethylene (HDPE), and/or polypropylene. The polystyrene may optionally comprise expanded polystyrene.

Preferably, the plastics comprise polyvinyl chloride and optionally one or more other plastics. It is desirable and preferable for polyvinyl chloride to be removed because it creates an undesirably high chloride loading in the feed supplied to step II). The plastics may optionally be recycled.

The inventors have found that the presence of plastic improves the H₂:CO ratio and synthesis gas energy content. However, the presence of plastic increases the need for caustic treatment of wastewater. Thus, it is likely that a dynamic optimum exists for various control parameters.

Thus, dynamic control of the plastics (high calorific, high C/H content and high Cl content, for example) in the process is a trade-off between “useable” synthesis gas and the high cost of wastewater treatment.

The density separation, through the use of a density separator, may optionally remove inerts, such as glass, stone, and grit, from the main feed.

It is desirable to maximise the removal of ferrous and non-ferrous metals from the feedstock. During step I), at least about 90%, or at least about 95%, or at least about 96%, or at least about 97%, or at least about 98%, or at least about 99%, of metals may optionally be removed from the feedstock.

It is desirable to maximise the removal of inert materials, and particularly larger inert materials, from the feedstock. During step I), at least about 80%, or at least about 85%, or at least about 90%, or at least about 95%, of inerts may optionally be removed from the feedstock. The inerts may preferably be dense inerts, such as glass and/or other non-combustibles. While it is important to also remove fine inerts, this should not be to the detriment of the overall quality of the solid recovered fuel (for example, by maximising the biogenic content of the solid recovered fuel compared to the inert content of the solid recovered fuel).

The final feed, prior to drying, may optionally comprise at least part of the fine feed. In other words, the final feed may optionally be combined with at least part of the fine feed.

The solid recovered fuel may optionally be continuously fed into step II), and thus advantageously does not require baling and/or storage of the solid recovered fuel.

Step II) comprises gasifying under suitable reaction conditions at least a portion of the solid recovered fuel to produce synthesis gas and by-product(s). Gasification may occur in the presence of steam and oxygen.

Step II) may optionally take place in a gasification zone. The gasification zone may optionally comprise a singular train, dual trains, or multiple trains. Preferably, the gasification zone comprises more than one train to minimise the impact of interruptions on the plant availability.

Three primary types of commercially available gasifiers are of fixed/moving bed, entrained flow, or fluidised bed type. The gasification zone may be an indirect gasification zone in which feedstock and steam are supplied to a gasification vessel which is indirectly heated. Alternatively, the gasification zone may be a direct gasification zone in which feedstock, steam and an oxygen-containing gas are supplied to the gasification vessel and directly combusted to provide the necessary heat for gasification. Also known in the art and suitable for use in the process of the present invention are hybrid gasifiers, and gasifiers incorporating partial oxidation units.

The gasification zone may optionally comprise primarily an indirectly heated deep fluidised bed operating in the dry ash rejection mode and a secondary gasifier, for maximal conversion of the solid recovered fuel. The gasification zone may optionally comprise only a primary indirectly heated fluidised bed.

The fluidised bed operating temperature may vary depending on the compositional characteristics of the solid recovered fuel. The fluidised bed operating temperature may optionally be between about 400 and 1000° C., or between about 500 and 900° C., or between about 600 and 800° C. Such temperature ranges of the fluidised bed have been found to avoid any constituent ash from softening and forming clinkers with the bed material.

The fluidised bed reactor may optionally be preloaded with a quantity of inert bed media such as silica (sand) or alumina. The inert bed media may be fluidised with superheated steam and oxygen. The superheated steam and oxygen may be introduced through separate pipe nozzles.

During gasification, the fluidised bed may undergo drying (or dehydration), devolatilization (or pyrolysis) and gasification. Some combustion, water gas shift and methanation reactions may also occur.

It is desirable to have a pressure within the gasification zone that minimises the need for compression in downstream processes. It is therefore preferable for the gasification zone to have a pressure of at least about 0.35 MPa (3.5 bar) if not higher, for example about 0.4 MPa (4 bar) or more. Gasification zones operating at even much higher pressures such as 1 MPa (10 bar) or more are known in the art. Gasification zones operating at even much lower pressures such as 0.15 MPa (1.5 bar) or less are also known in the art. Gasification zones with all operating pressures are suitable for use in the process of the present invention.

The synthesis gas leaving step II) of the process may optionally have an exit temperature of at least about 600° C., or of at least about 700° C., or of at least about 800° C. Preferably, the synthesis gas leaving step II) of the process has an exit temperature of from about 700° C. to about 750° C.

The major products of step II) are typically steam and synthesis gas comprised of hydrogen and carbon monoxide (CO) (the essential components of synthesis gas), carbon dioxide (CO₂), methane, and small amounts of nitrogen and argon. There may be additional components such as benzene, toluene, ethyl benzene and xylene, higher hydrocarbons, waxes, oils, ash, soot, bed media components and other impurities present.

In order to obtain high-quality gas that is required for its use as a feedstock in downstream processes such as synthesis, the impurities need to be removed. Non-limiting examples of suitable synthesis include Fischer-Tropsch synthesis, ammonia synthesis, methanol synthesis, or as a hydrogen product.

Cyclones may optionally be used to remove undesirable solid materials from the synthesis gas.

A tramp discharge system may optionally be used to remove heavier contaminants from the bed material in operation of the gasification process.

Carbon dioxide, sulphur, slag and other by-products and impurities of gasification may be amenable to capture, collection and reuse.

Depending on the source of the feedstock used, the ratio of main components and impurities present in the synthesis gas may vary, and the hydrogen to carbon monoxide ratio of the synthesis gas can vary substantially. In particular, there will be greater fluctuation in the hydrogen to carbon monoxide ratio of the synthesis gas when waste feedstock is used as the feedstock source due to the swings in compositional chemistry and variable moisture present.

Depending on the source of the feedstock and the gasification technology, the synthesis gas may typically comprise between about 3 and 40 mol % carbon dioxide.

The synthesis gas leaving step II) may optionally comprise a varying sulphur concentration depending on the source of the feedstock being gasified, typically in the hundreds of ppmv. The synthesis gas leaving step II) may optionally comprise a sulphur concentration of less than about 500 ppmv, less than about 400 ppmv, less than about 300 ppmv, less than about 200 ppmv. Preferably, the synthesis gas comprises a sulphur concentration of less than about 200 ppmv. The concentration of sulphur in the synthesis gas will influence the process conditions that are employed downstream.

The synthesis gas may optionally be treated to adjust the molar ratio of H₂ to CO by steam reforming (e.g., a steam methane reforming (SMR) reaction where methane is reacted with steam in the presence of a SMR catalyst); partial oxidation; autothermal reforming; carbon dioxide reforming; water gas shift reaction; or a combination of two or more thereof.

The term “water gas shift reaction” or “WGS” is to be construed as a thermochemical process comprising converting carbon monoxide and water into hydrogen and carbon dioxide. The synthesis gas obtained after the WGS reaction may be construed to be shifted (i.e. adjusted) synthesis gas.

Step III) may optionally comprise a primary clean-up zone supplied with an aqueous stream at least partially to wash particulates and ammonia or HCl out of the synthesis gas, the aqueous stream being selected to be a neutral or acidic aqueous stream when ammonia is a contaminant in the synthesis gas and being selected to comprise a basic aqueous stream when HCl is a contaminant in the synthesis gas, to provide an aqueous-washed synthesis gas comprising H₂, CO, CO₂ and contaminants comprising sulphurous gas.

A caustic wash may optionally be used to remove impurities such as ammonia, halides, nitrous oxides, and remaining particulates.

Step III) may optionally further comprise supplying at least a portion of the aqueous-washed synthesis gas to a secondary clean-up zone; contacting the aqueous-washed synthesis gas in the secondary clean-up zone with a solvent for sulphurous materials effective at least partially to absorb sulphurous materials from the aqueous-washed synthesis gas and recovering from the secondary clean-up zone an at least partially desulphurised, de-tarred aqueous-washed synthesis gas comprising H₂, CO, CO₂ and, optionally, remaining contaminants.

Step III) may optionally further comprise supplying the at least partially desulphurised, de-tarred aqueous-washed synthesis gas to a tertiary clean-up zone; contacting the at least partially desulphurised, de-tarred aqueous-washed synthesis gas in the tertiary clean-up zone with a solvent for CO₂ effective at least partially to absorb CO₂ from the at least partially desulphurised, de-tarred aqueous-washed synthesis gas, and recovering from the tertiary clean-up zone a first stream comprising the physical solvent for CO₂ and absorbed CO₂, and a second stream comprising clean synthesis gas comprising H₂, CO and optionally remaining contaminant; removing at least part of the absorbed CO₂ from the first stream in a solvent regeneration stage to recover regenerated solvent and separately CO₂ in a form sufficiently pure for sequestration or other use.

In other words, acid gas (H₂S and CO₂) removal from the synthesis gas may optionally be effected by the Rectisol™ process using a methanol solvent which “sweetens” the synthesis gas. The sulphur-rich off-gas stream from the Rectisol™ process may optionally be combusted with an excess of air to convert all sulphur-containing compounds to SO₂. The resulting gas may optionally be used to raise steam and is thereby cooled. It may optionally be washed with a sodium hydroxide solution to remove the SO₂ as sodium sulphite and sodium sulphate.

The wastewater may optionally be sent to a wastewater treatment unit before disposal or possible reuse.

The molar ratio of H₂ to CO in the (clean) synthesis gas is preferably in the range from about 1.6:1 to about 2.2:1, or from about 1.8:1 to about 2.1:1, or from about 1.95:1 to about 2.05:1.

The (clean) synthesis gas may optionally be converted into a useful product, for example long chain hydrocarbons. The useful product may for example comprise liquid hydrocarbons. The liquid hydrocarbons may for example be sustainable liquid transportation fuels. The useful product may optionally be naphtha, diesel or aviation fuel. Alternatively or additionally, the useful product may be liquefied petroleum gas (LPG), which comprises propane and/or butane. The useful product may optionally be produced by subjecting at least part of the synthesis gas to a Fischer-Tropsch synthesis reaction.

Therefore, according to another aspect of the present invention, there is provided a useful product manufactured by converting the synthesis gas produced by a process according to the first aspect of the invention.

At least a portion of the synthesis gas may optionally be fed into a synthesis unit. Non-limiting examples of suitable synthesis include Fischer-Tropsch, ammonia synthesis, methanol synthesis, alcohol synthesis or as a hydrogen product.

Solid Recovered Fuel

According to another aspect of the present invention, there is provided a solid recovered fuel produced by step I) of a process according to the first aspect of the invention.

The solid recovered fuel may optionally comprise a particle size of less than about 25 mm in two dimensions.

At least about 85%, or at least about 90%, or at least about 95%, by weight of the solid recovered fuel may be about 16,400 mm³ (1 in 3) or less in volume, depending on the requirements of the gasification technology deployed.

The solid recovered fuel may optionally comprise no more than about 5% by weight of the solid recovered fuel being greater than about 75 mm in length.

The solid recovered fuel may optionally comprise no more than about 15% by weight of the solid recovered fuel being smaller than about 840 μm in length.

The solid recovered fuel may optionally comprise an average moisture content of from about 1% to about 20%, or from about 5% to about 15%, or about 10%. The solid recovered fuel may optionally comprise a moisture content of less than about 20%, less than about 15%, or less than about 10% by weight. The solid recovered fuel may optionally have a moisture content of at most 10% by weight. A higher moisture content can be processed but at the expense of throughput, whereas a lower moisture content is challenging to achieve and leads to other operational difficulties (for example, fire risk, or a negative impact on flowability through the feeders to the gasifier).

The solid recovered fuel may optionally comprise less than about 1% by weight of chloride. It is highly undesirable for the synthesis gas to be contaminated with chlorides.

The solid recovered fuel may optionally comprise a calorific value of from about 14 to about 22 MJ/kg.

It is particularly important to analyse the biogenic content because there is a commercial desire to ensure that the solid recovered fuel contains maximum biogenic content. The biological carbon content of the solid recovered fuel and the feedstock may differ depending on the source.

The biogenic carbon content of the feedstock may be from about 50% to about 80%, or from about 59% to about 75%, or about 67%, by weight of total carbon content in the feedstock.

The biogenic carbon content of the SRF may be from about 60% to about 85%, or from about 67% to about 81%, or about 75%, by weight of total carbon content in the SRF.

According to another aspect of the present invention, there is provided a synthesis gas produced by a process according to the first aspect of the invention.

### Product Analysis and Process Parameters

The analysis of the feed(s), the stages of the process, and/or the products of the process may optionally be performed continuously throughout the process. The inventors of the present invention have found that the process of converting feedstock to solid recovered fuel can be controlled responsive to real-time analytical feedback, in a series of continuous feedback loops. For example, the products of the gasification, and the process of gasification itself, may be continuously analysed to control parameters of the process of converting feedstock to solid recovered fuel.

Alternatively, analysis of the feed(s), the stages of the process, and/or the products of the process may optionally be performed at discreet intervals, for example once every minute, or once every hour, or once every day, or any appropriate time interval. The time intervals may optionally be the same, or each time interval may optionally be different.

The solid recovered fuel may optionally be analysed to determine one or more of average particle size, average volume, moisture content, calorific value, wt. % of chlorides, wt. % of sulphur, biogenic content, wt % of inert non-fluidisable material and chemical composition.

It is particularly important to analyse the biogenic content because there is a commercial desire to ensure that the solid recovered fuel contains maximum biogenic content.

One or more of the feedstock, the fine feed, the small feed, the main feed, the light coarse feed, the medium coarse feed, and/or the heavy coarse feed may optionally be analysed.

Data from the analysis may optionally include information concerning the chemical composition, pressure and/or temperature of the synthesis gas during operation of the process.

The synthesis gas may optionally be analysed to determine one or more of H₂:CO ratio, C₁₄/C₁₂ ratio, moisture content, wt. % of chlorides, and wt. % of inerts.

The C₁₄/C₁₂ ratio may be used to measure biogenic content. This measurement allows the process of the present invention to adjust the FCF operation responsive to such analysis to maximise biogenic carbon, if required, by feeding the fine rejects back into the SRF, for example.

The primary inerts are typically CO₂ and nitrogen, which reflect the changes in oxygen content of the waste (more CO₂ in the raw synthesis gas from the gasifier, for example) and the tramp removal rate which requires a greater amount of CO₂ to be utilised to change out the gasifier bed material. If the tramp removal rate increases, more CO₂ is required to manage the removal process, which results in both a high CO₂ demand, as well as the introduction of more CO₂ to the synthesis gas, which significantly impacts the reaction conditions of downstream processes.

The synthesis gas may also be analysed for sulphur compounds, which may optionally be fed back into the FCF to target high sulphur content materials.

Each of these parameters are possible control items for the FCF and advantageously may be controlled and/or adjusted responsive to analytical feedback.

The by-product(s) of the gasification may optionally be analysed to determine tramp material mass flow.

The gasification reaction itself may optionally be analysed to determine one or more of gasifier temperature, oxygen consumption, tramp removal rate and fuel gas consumption. The gasifier may optionally comprise one or more agglomeration detectors to analyse the formation of sticky materials.

The wastewater from step III) may optionally be analysed to determine wt. % of chlorides, and/or total flow of chlorides.

The parameters of step I) which can be controlled may optionally comprise one or more of:

selection of the feedstock;

operation of the first, second and/or third screening (such as, for example, air flow and/or throughput);

operation of the density separator;

belt speed of the belt dryer;

residence time in the belt dryer;

amount of heat supplied in the belt dryer;

flow rate of the feedstock through the process;

type and quantity of the one or more plastics removed during the near-infrared scanning;

addition of fine feed to final feed;

rejection of one or more of the feed(s) to storage or disposal; and

quantity of feedstock in each of the fine feed, the small feed, the main feed, the light coarse feed, the medium coarse feed, and the heavy coarse feed.

The feedstock may be provided from two or more distinct feed hopper systems. One or more of said hoppers may be a bio hopper, and one or more of said hoppers may be a non-bio hopper. Controlling the input from said feed hopper systems may influence the properties of the synthesis gas. The C₁₂/C₁₄ ratio of the synthesis gas may optionally be analysed and used to control the input from said feed hopper systems.

The feedstock may optionally be selected to include one or more of refuse derived fuel, solid recovered fuel with specific properties, and/or imported biogenic rich material (for example, anaerobic digester digestate).

According to another aspect of the present invention, there is provided a control unit for monitoring a process according to the first aspect of the invention.

For avoidance of doubt, all features relating to the process for obtaining solid recovered fuel and synthesis gas from a waste-based feedstock, also relate, where appropriate, to the solid recovered fuel produced by the process, the synthesis gas produced by the process, the useful product manufactured by converting the synthesis gas produced by the process, and the control unit for monitoring the process, and vice versa.

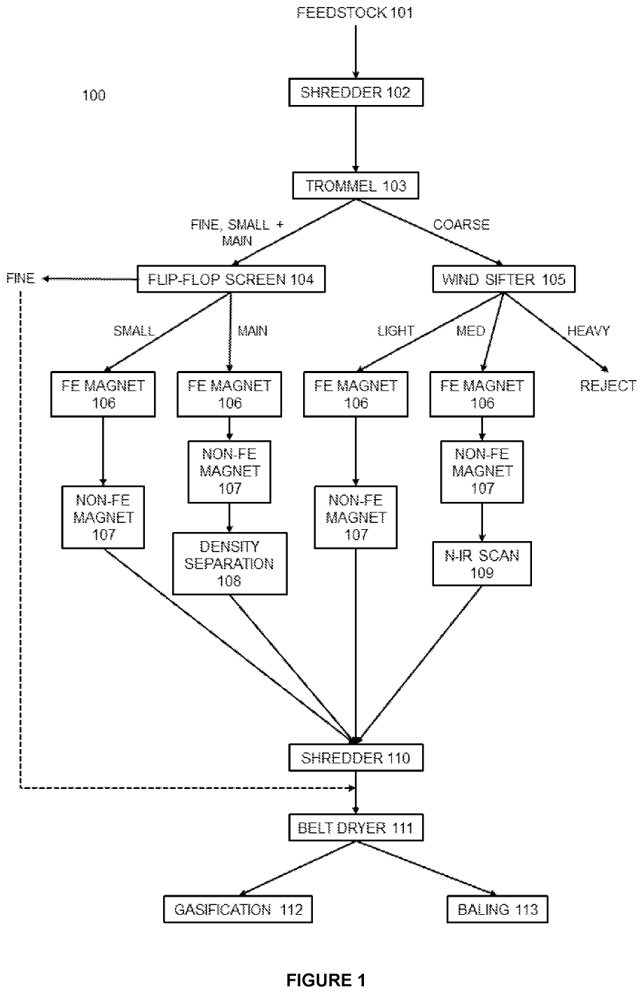

Preferred embodiments of the invention are described below by way of example only with reference to FIGS. 1 to 3 of the accompanying drawings, wherein;

FIG. 1 illustrates the process of obtaining solid recovered fuel from a feedstock in accordance with one embodiment of the invention.

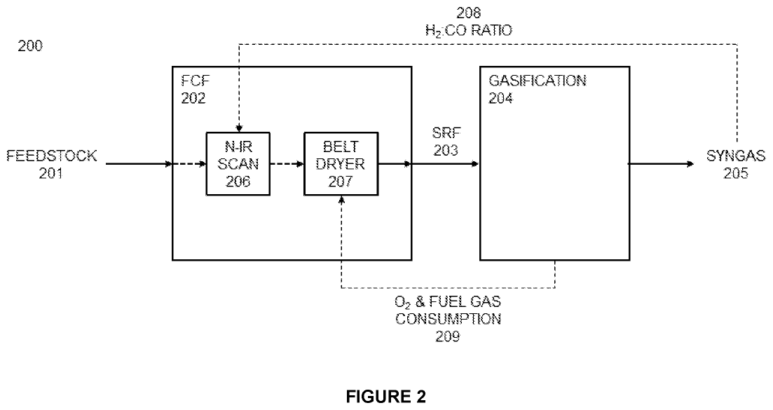

FIG. 2 illustrates the feedback loops involved in steps I) and II) of the process in accordance with one embodiment of the invention.

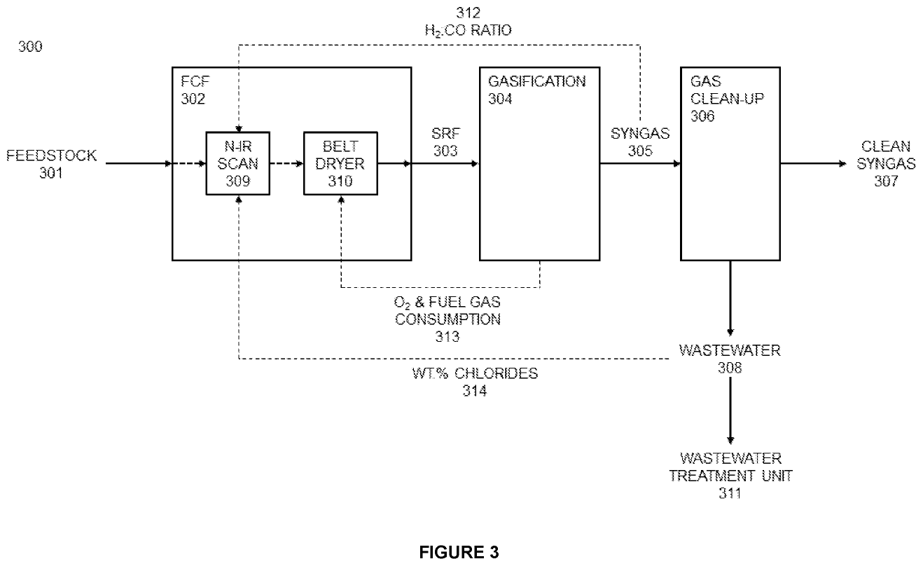

FIG. 3 illustrates the feedback loops involved in steps I), II) and III) of the process in accordance with one embodiment of the invention.

### Production of Solid Recovered Fuel

FIG. 1 illustrates the process of obtaining solid recovered fuel from a feedstock in accordance with one embodiment of the invention. At the start of the process, a feedstock 101 is provided. The feedstock can be household, or co-collected house and commercial waste, which is also called municipal solid waste (MSW). Alternatively, the feedstock can be separately collected commercial and industrial waste (C&I).

The raw feedstock 101 is delivered to a feedstock reception area, where it is then loaded into a shredder 102. There may be a single shredder, or a plurality of shredders wherein the feedstock 101 is shared between said plurality of shredders. The feedstock is shredded to 250 mm.

The shredded material is then passed through a trommel screening process 103. This screening separates the material into a fraction with a size greater than 60 mm (the coarse feed) and into a fraction with a size less than 60 mm (the fine, small, and main feed). Depending on the screen size of the trommel (as the screen size may vary as a parameter which may be controlled in accordance with the invention and may not always be 60 mm), 2D materials pass through the trommel and 3D materials are screened off for separate processing.

The large fraction (termed the coarse feed) is then passed through a wind sifter 105, which uses a continuous jet of air to separate materials. The wind sifter 105 separates the coarse feed into heavy materials, light materials, and medium materials. The heavy materials, light materials and medium materials are also termed the heavy coarse feed, light coarse feed, and medium coarse feed respectively.

The heavy materials consist of inerts and glass and are rejected from the process because they cannot be used to form compliant solid recovered fuel. The light materials consist predominantly of paper and plastics. These materials are passed over a ferrous magnet 106 and a non-ferrous magnet 107 to maximise metal removal. The medium materials consist of heavier paper, card, and plastics, including polyvinyl chloride. These materials are passed over a ferrous magnet 106 and a non-ferrous magnet 107 to maximise metal removal. The medium materials are then passed through a near-infrared scanner 109 to identify and remove polyvinyl chloride based materials. Alternatively or additionally, the near-infrared scanner 109 may identify and remove other plastics. After these steps, the light materials and medium materials are delivered to the final shredder 110.

The smaller fraction separated at the trommel screening process 103 is subjected to different steps than the larger fraction. The smaller fraction (the fine feed, small feed and main feed) is passed through a double deck flip flop screen 104. This screening separates the material into a fraction with a size of from about 20 mm to about 60 mm (the main feed), into a fraction with a size of from about 6 mm to about 20 mm (the small feed), and into a fraction with a size less than about 6 mm (the fine feed). Both feeds are passed over a ferrous magnet 106 and a non-ferrous magnet 107 to maximise metal removal. The main feed is then subjected to a density separation 108 to remove any remaining inerts and glasses, which are to be rejected from the process. After these steps, the small feed and main feed are delivered to the final shredder 110.

All those feeds which are delivered to the final shredder 110 are shredded to a size of 25 mm, which conforms to the required specification of the solid recovered fuel. The shredded solid recovered fuel is then delivered to a belt dryer 111. Prior to delivery to the belt dryer 111, at least part of the fine feed, which was separated at the flip flop screen 104, may be added to the shredded solid recovered fuel.

All of the shredded solid recovered fuel may be delivered to a single belt dryer 111 or may be distributed across a plurality of belt dryers 111. The belt dryer 111 reduces the moisture content of the solid recovered fuel to less than, or equal to, about 10 wt. %.

The dried solid recovered fuel is sampled on leaving the belt dryer and analysed. The solid recovered fuel is analysed to determine one or more of the average particle size, the average volume, the moisture content, the calorific value, the wt. % of chlorides, the wt. % of sulphur, the biogenic content, the chemical composition, the grit content, the glass content and the inert content.

The remaining dried solid recovered fuel is delivered either to the gasifier feed systems for gasification 112, or to baling 113 for storage or export. The solid recovered fuel entering the gasification step 112 or sent for baling 113 needs to meet certain specifications, which are primarily determined by the requirements of the gasification step 112.

### Feedback Loops

FIG. 2 illustrates the feedback loops involved in steps I) and II) of the process in accordance with one embodiment of the invention. In the illustrated process, feedstock 201 is converted into a solid recovered fuel 203 in a fuel conversion facility (FCF) 202. At least a portion of the solid recovered fuel 203 is delivered to a gasification step 204 where it is gasified to produce synthesis gas (syngas) 205.

Two of the steps which the feedstock may be subjected to in the fuel conversion facility 202 include a near-infrared scan 206, to remove plastic such as polyvinyl chloride, and a belt dryer 207, to vary the moisture content of the solid recovered fuel. The dashed arrows between the feedstock 201 and the near-infrared scan 206, and between the near-infrared scan 206 and the belt dryer 207, indicate that other steps may optionally also be present but not illustrated.

Exemplified in FIG. 2 are two feedback loops in accordance with the invention.

The first feedback loop is between the synthesis gas 205 and the near-infrared scanner 206. After gasification 204, the synthesis gas 205 is analysed to determine the H₂:CO ratio. This ratio is important as a certain ratio is required for downstream reaction operations, such as Fischer-Tropsch synthesis. However, the H₂:CO ratio of the synthesis gas 205 will be entirely dependent on the nature of the feedstock 201, because in a chemical process plant handling mixed feedstock streams derived from waste there is inherent and significant variability in the nature of the feedstock. As a result, downstream processing of the synthesis gas 205 is freighted with difficulty because of the variable nature of such gas arising from different feedstocks at different times in the production cycle. Wide variation in the synthesis gas H₂:CO ratio creates problems in consistently and efficiently adjusting that ratio for suitability with the selected downstream reaction operation. This is particularly the case when the variability of feedstock is such as to give rise from time to time to H₂:CO ratios which are above the preferred usage ratio of the downstream reaction.

Therefore, to provide a solution to this problem, data from the analysis of the synthesis gas 205 can be used to actively manage the amount of removal of high hydrogen contributing wastes, such as plastics, at the near-infrared scanner 206. The consequence of this is that the H₂:CO ratio can be adjusted to account for the variations in the feedstock. This exemplifies how the present invention advantageously uses feedback loops which extend beyond solely within the fuel conversion facility 202, in that the products of downstream processes are analysed to control and influence upstream processes.

The second feedback loop is between the gasification step 204 and the belt dryer 207. The oxygen consumption and fuel gas consumption during the gasification step 204 is dependent on the moisture content of the solid recovered fuel 203. Therefore, the oxygen consumption and fuel gas consumption are analysed and used to control parameters of the belt dryer 207 in order to increase or decrease the amount of moisture removed from the solid recovered fuel during this step. Such parameters include the belt speed of the belt dryer 207, residence time in the belt dryer 207, and amount of heat supplied in the belt dryer 207.

FIG. 3 illustrates the feedback loops involved in steps I), II) and III) of the process in accordance with one embodiment of the invention. In the illustrated process, feedstock 301 is converted into a solid recovered fuel 303 in a fuel conversion facility (FCF) 302. At least a portion of the solid recovered fuel 303 is delivered to a gasification step 304 where it is gasified to produce synthesis gas (syngas) 305. At least a portion of the synthesis gas 305 is cleaned to produce clean synthesis gas 307 and wastewater 308. Other steps between the gasification 304 and gas clean up 306 may optionally also be present but not illustrated. The wastewater 308 is passed to a wastewater treatment unit 311 prior to disposal or reuse.

Two of the steps which the feedstock may be subjected to in the fuel conversion facility 302 include a near-infrared scan 309, to remove plastic such as polyvinyl chloride, and a belt dryer 310, to reduce the moisture content of the solid recovered fuel. The dashed arrows between the feedstock 301 and the near-infrared scan 309, and between the near-infrared scan 309 and the belt dryer 310, indicate that other steps may also be present but not illustrated.

Exemplified in FIG. 3 are three feedback loops in accordance with the invention.

The first feedback loop is between the synthesis gas 305 and the near-infrared scanner 309. After gasification 304, the synthesis gas 305 is analysed to determine the H₂:CO ratio. This ratio is important as a certain ratio is required for downstream reaction operations, such as Fischer-Tropsch synthesis. However, the H₂:CO ratio of the synthesis gas 305 will be entirely dependent on the nature of the feedstock 301. Therefore, depending on the results of the analysis of the synthesis gas 305, data from said analysis can be used to actively manage the amount of removal of high hydrogen contributing wastes, such as plastics, at the near-infrared scanner 309.

The second feedback loop is between the gasification step 304 and the belt dryer 310. The oxygen consumption and fuel gas consumption during the gasification step 304 is dependent on the moisture content of the solid recovered fuel 303. Therefore, the oxygen consumption and fuel gas consumption are analysed and used to control parameters of the belt dryer 310 in order to increase or decrease the amount of moisture removed from the solid recovered fuel during this step. Such parameters include the belt speed of the belt dryer 310, residence time in the belt dryer 310, and amount of heat supplied in the belt dryer 310.

The third feedback loop is between the wastewater 308 and the near-infrared scanner 309. Polymers such as polyvinyl chloride in the feedstock 301 contaminate the synthesis gas 305 with chlorides, which must be removed during the gas clean up 306. As a result, the clean synthesis gas 307 is substantially free of chlorides, and the wastewater 308 may contain chlorides which have been removed from the synthesis gas 305. This wastewater 308 is sent to a wastewater treatment unit 311 before disposal or possible reuse. The wastewater treatment unit 311 is required to remove chlorides from the wastewater 308 so that the water can be safely disposed or reused. The amount of treatment required depends on the amount of chloride present in the wastewater, which in turn is dependent on the amount of chloride-containing materials in the feedstock 301. Therefore, the wastewater 308 is analysed to determine the wt. % of chlorides, and the data from said analysis is used to actively manage and control the removal of high chloride contributing wastes (such as polyvinyl chloride) from the feedstock at the near-infrared scanner 309.

In some instances, there will be an interplay, and a necessary balance, between different feedback loops. For example, reducing the removal of high hydrogen contributing wastes, such as plastics, at the near-infrared scanner 309 will improve the H₂:CO ratio and the synthesis gas 305 energy content. However, this consequently increases the need for caustic treatment of the wastewater 308. Therefore, there may be a dynamic optimum that exists for the relevant controlled parameters.

A further exemplary feedback loop in accordance with the invention is in controlling the calorific value of the solid recovered fuel by analysing and monitoring the heat input to the gasifier per unit mass of feedstock. A lower heating value may be corrected through an increased removal of moisture content at the belt dryer 310 and/or the addition of higher heating value materials such as plastic (in other words, less plastic is removed during the near-infrared scan 309). On the other hand, a higher than expected heating value may be corrected through a decreased removal of moisture content at the belt dryer 310 (such that the solid recovered fuel has a higher moisture content than before the correction) and/or the removal of higher heating value materials such as plastic (in other words, a greater amount of plastic is removed during the near-infrared scan 309).

A further exemplary feedback loop in accordance with the invention is in influencing the volume of caustic soda required in the caustic wash by analysing and monitoring the quantity of reactive halides in the solid recovered fuel.

A further exemplary feedback loop in accordance with the invention is in analysing the by-product(s) of the gasification to determine tramp material mass flow, and/or using the agglomeration detectors in the gasifier to analyse the formation of sticky materials. These can be used to control the ferrous and non-ferrous metal removal, and/or to control the density separation of the main feed. The density separation efficiency directly impacts the tramp removal rate. If the tramp removal rate increases, more CO₂ is required to manage the removal process. This undesirably results in both a high CO₂ demand, as well as introducing more CO₂ to the synthesis gas, and thus influencing the reaction conditions of downstream processes. Therefore, analysing the tramp removal rate and controlling the density separation efficiency influences the quantity of CO₂ in the synthesis gas.

1. A process for obtaining solid recovered fuel and synthesis gas from a waste-based feedstock, comprising the steps of:
(I) converting the feedstock into a solid recovered fuel by means of a number of parameters pertaining to waste sorting, selection, comminution and/or screening;
(II) gasifying under suitable reaction conditions at least a portion of the solid recovered fuel to produce synthesis gas and by-product(s); and
(III) optionally cleaning at least a portion of the synthesis gas to produce clean synthesis gas and wastewater,
wherein one or more of the solid recovered fuel, synthesis gas, and by-product(s) of the gasification are analysed during operation of the process, and wherein data from said analysis is used to control one or more parameters of step (I) in order to influence reaction conditions in step (II), and optionally step (III).

2. The process of claim 1, wherein said data includes information concerning the chemical composition, pressure and/or temperature of the synthesis gas during operation of the process.

3. The process according to claim 2, wherein the synthesis gas is analysed to determine one or more of H₂:CO ratio, C₁₄/C₁₂ ratio, moisture content, wt. % of chlorides, and wt. % of inerts.

4. The process according to claim 1, wherein the solid recovered fuel is analysed to determine one or more of average particle size, average volume, moisture content, calorific value, wt. % of chlorides, wt. % of sulphur, biogenic content, chemical composition, grit content, glass content and inert content.

5. The process according to claim 1, wherein the by-product(s) of the gasification are analysed to determine tramp material mass flow.

6. The process according to claim 1, wherein the wastewater is analysed to determine wt. % of chlorides, and/or total flow of chlorides.

7. The process according to claim 1, wherein the parameters of step I) comprise:
providing a feedstock which comprises a fine feed, a small feed, a main feed, and a coarse feed;
shredding the feedstock to a first size;
subjecting the feedstock to a first screening, which separates the fine feed, small feed and main feed from the coarse feed;
subjecting the fine feed, small feed and main feed to a second screening, which separates the fine feed, the small feed, and the main feed;
subjecting the coarse feed to a third screening, which separates the coarse feed into a light coarse feed, a medium coarse feed, and a heavy coarse feed;
conveying one or more of the small feed, the main feed, the light coarse feed, and/or the medium coarse feed over one or more magnets to remove ferrous and/or non-ferrous metals from said one or more feeds;
near-infrared scanning the medium coarse feed to identify and remove one or more plastics;
subjecting the main feed to a density separation;
shredding the small feed, the main feed, the light coarse feed, and the medium coarse feed to a second size;
combining the small feed, the main feed, the light coarse feed, and the medium coarse feed into a final feed; and
drying the final feed, optionally by using a belt dryer, to produce a solid recovered fuel.

8. The process according to claim 7, wherein the first screening is a trommel screen; and/or wherein the second screening is a flip-flop screen; and/or wherein the third screening is a wind sifter.

9. The process according to claim 7, wherein the first size is about 250 mm and/or wherein the second size is about 25 mm.

10. The process according to claim 7, wherein the plastics comprise one or more of polyvinyl chloride, a polyolefin, polystyrene, polyacrylonitrile, a polyacrylate, a polyurethane, a polyamide, a polyester, a polycarbonate, and an elastomer.

11. The process according to claim 7, wherein the density separation removes inerts, such as glass, stone, and grit, from the main feed.

12. The process according to claim 7, wherein one or more of the feedstock, the fine feed, the small feed, the main feed, the light coarse feed, the medium coarse feed, and/or the heavy coarse feed is analysed.

13. The process according to claim 7, wherein the parameters of step I) further comprise one or more of:
selection of the feedstock;
operation of the density separator;
operation of the first, second and/or third screening;
belt speed of the belt dryer;
residence time in the belt dryer;
amount of heat supplied in the belt dryer;
flow rate of the feedstock through the process;
type and quantity of the one or more plastics removed during the near-infrared scanning;
addition of fine feed to final feed;
rejection of one or more of the feed(s) to storage or disposal; and
quantity of feedstock in each of the fine feed, the small feed, the main feed, the light coarse feed, the medium coarse feed, and the heavy coarse feed.

14. The process according to claim 1, wherein the analysis is performed continuously throughout the process.

15. The process according to claim 1, wherein the feedstock comprises one or more of household waste, commercial and industrial waste, and co-collected household and commercial waste.

16. The process according to claim 1, wherein at least about 95% of metals are removed from the feedstock and/or at least about 80% of inerts are removed from the feedstock.

17. The process according to claim 1, wherein the solid recovered fuel comprises one or more of:
a particle size of less than about 25 mm in two dimensions;
at least about 95% by weight of the solid recovered fuel having a volume of about 16,400 mm³ or less;
no more than about 5% by weight of the solid recovered fuel being greater than about 75 mm in length;
no more than about 15% by weight of the solid recovered fuel being smaller than about 840 μm;
an average moisture content of from about 5% to about 15%, or about 10%;
less than about 1% by weight of chloride; and
a calorific value of from about 14 to about 22 MJ/kg.

18. Solid recovered fuel produced by step I) of a the process according to claim 1.

19. Synthesis gas produced by the process according to claim 1.

20.-22. (canceled)
